(19) United States
(12) Patent Application Publication
(10) Pub. No.: US 2026/0321988 A1
(43) Pub. Date: Oct. 15, 2026

(54) ADDITIVE MANUFACTURED DIELECTRIC ARCHITECTURES AND METHODS FOR PRODUCING THE SAME

(71) Applicant: 3DFortify Inc., Boston, MA (US)

(72) Inventors: Philip Lambert, Cambridge, MA (US); Colby Hobart, Shrewsbury, MA (US); Joshua A. Martin, Boston, MA (US)

(21) Appl. No.: 19/106,550

(22) PCT Filed: Aug. 25, 2023
(86) PCT No.: PCT/US2023/031205

§ 371 Date: Feb. 25, 2025

Related U.S. Application Data
(60) Provisional application No. 63/401,121, filed on Aug. 25, 2022.

(51) Int. Cl. H01Q 15/08; B33Y 40/20; B33Y 80/00

(52) U.S. Cl. CPC H01Q 15/08; B33Y 40/20; B33Y 80/00

(57) ABSTRACT

Novel dielectric foam structures for use as in radio frequency (RF) devices are provided. For example, additively manufactured dielectric foam (AMDF) structures suitable for replacing foams in the context of antenna substrates, and methods of manufacture such foams and substrates, can be used to withstand crushing and high temperatures when being laminated, and exhibit increased versatility. The AMDFs of the present embodiments can include anisotropic lattice structures to expose electromagnetic waves a lower Dk when traversing the AMDF in a specific direction. The anisotropic AMDFs can be planar and/or conformal, and include a plurality of skins having a plurality of columns therebetween. Tuning of a thickness, density, and/or height of the columns can modulate the effective Dk and a cutoff frequency of the AMDF

### CROSS REFERENCE TO RELATED APPLICATION

The present disclosure claims priority to U.S. Provisional Application No. 63,401/121, entitled “Low-Loss Dielectric Lattice-Based Structures and Methods for Producing the Same,” which was filed on Aug. 25, 2022, and which is incorporated by reference herein in its entirety.

### FIELD

The present disclosure relates to utilizing additive manufacturing to dielectric foam structures for use as a radio frequency (RF) device, and more particularly relates to producing such structures such that they are suitable for replacing foams, for example in the context of antenna substrates.

### BACKGROUND

Traditional foams are used in a variety of contexts, including on printed circuit boards (PCBs) for radio frequency (RF) device such as antenna, the foams serving as antenna substrates. In some of these uses, the traditional foam can serve as a core of the overall structure. Some common traditional foam brands include AIREX® foams and ROHACEL® foams. These cores are made of a relatively soft, closed cell, air-filled foam that contains a high enough air content to create a very small effective dielectric constant (Dk) value, on the order of 1.01. Although such traditional foams are commonplace in various industries, there are also a number of issues that plague traditional foams.

One such issue is their performance when being laminated. Traditional foams are often laminated for use as a PCB, as well as in other structural designs as a way to reduce weight. Under the temperature and pressure of lamination conditions, some amount of crushing occurs in the foam core. Likewise, crushing often occurs during the operation of laminating a foam core to a PCB using an adhesive sheet or pre-impregnated sheet, an operation that is performed when using foam cores in conjunction with RF devices. Thus, the crushing must be accounted for during the manufacturing process to insure that the foam core finishes at a thickness that is within a mechanical tolerance indicated in the initial design (e.g., a design provided by customer blueprints). The crushing can be even more problematic if it occurs unevenly, as it can be more difficult to attend to falling within the mechanical tolerances across the whole part when uneven crushing occurs. Uneven crushing can negatively impact performance, such as for antennas where an uneven crush can result in antennas in an array being unequal.

Further, the range of available pre-impregnated sheets or adhesive sheets that can be used to laminate traditional rigid foam cores to a PCB are limited, due at least in part to the processing temperature limits of traditional foam cores paired with the pressure limits due to the aforementioned crush factor. Additionally, traditional rigid foams cannot typically have planar plating directly applied to its surface. Thus, to achieve a structure such as a patterned copper on the surfaces of the foam, multi-step processes such as patterning and etching a thin copper-clad dielectric and then laminating it to the surface of the foam core are employed.

Still a further drawback to traditional foam cores is that they cannot have plated-through holes for providing a DC connection between copper disposed on two opposing surfaces of the core. Plating chemistry would attack the foam and the hole diameter would, at best, be inconsistent top-to-bottom due, at least in part, to the cells in the foam. Additionally, traditional foam cores cannot have additional 3D shapes, such as solid patches for patch antennas to land on, nor can they have shaped through holes for plating.

Accordingly, there is a need for improved structures that can be used in the way traditional foams are used, including in conjunction with RF devices, but allow for more customizability and/or easier manufacturing while still achieving similar, if not better, performance results (e.g., desirable effective dielectric constant values).

### SUMMARY

The present disclosure is directed to a traditional foam replacement, sometimes referred to herein as an Additive Manufacture Dielectric Foam (AMDF). The AMDF can be structurally similar to traditional foam, but the configuration and composition of the AMDF is such that it avoids some of the aforementioned issues that plague traditional foam. For example, the AMDFs of the present disclosure do not crush under pressure as easily as traditional foam cores. Rather, the AMDFs break above a significantly higher pressure threshold than the pressure at which foam is typically laminated. In contrast, existing traditional foams crush much more easily. For example, typical board shop lamination occurs at about 30 psi, and even then the crush that results is noticeable to the eye and in its impact on performance.

By way of further example, the AMDFs can withstand substantially more pressure and heat than traditional foam cores. This is true both for submitting the materials to high temperatures during a lamination process, as well as the materials operating in their intended devices (e.g., RF devices) in the field. Traditional foams can fail under roughly 0.7 MPa of pressure with processing temperatures up to 130 °C, while AMDFs of the present disclosure may be able to withstand temperatures of about 180 °C or greater with more than 1.82 MPa of pressure. The combination of crush resistance and heat resistance can provide a significantly wider range of potential adhesive sheets and pre-impregnated sheets that can be used to perform lamination with the AMDFs as compared to sheets that can be used to perform lamination with traditional foam cores, with the crush resistance likely being a more important performance factor.

The AMDFs can be a core having thin solid sheets printed at a top and/or bottom of a body of the core. The body can be an air/dielectric mix, with the thin solid sheets being able to serve as a landing pad for metal plating (e.g., copper plating). For example, selective or full copper plating can be applied and etched back as desired. Further, holes can be printed through the air/dielectric mixed body with thin solid walls, which can be helpful to accept plating to create plated through holes. This can provide DC connectivity between the top and bottom metal plates. A further benefit that results from the present disclosures is that advanced three-dimensional shapes can be integrated into the printed parts. This allows for the creation of a wider variety of shaped and sized objects (e.g., RF devices, antennas, etc.) than is possible when utilizing traditional foam. By way of non-limiting examples, in view of the present disclosures, shapes such as patch antennas in a dish shape for beam focusing, patch antennas on mound shapes for beam dispersion, and/or multiple patch antennas on outward facing sides of a mount of sphere for multi-directional transmit/receive can all be possible.

One exemplary embodiment of a lattice-based structure that includes a body that comprises a mix of low-loss dielectric material and air. The body includes a first skin surface disposed at a first end of the body; a second skin surface disposed at a second end of the body; and a plurality of columns disposed between the first skin surface and the second skin surface. The body is anisotropic in a single direction.

An effective Dk of the body in the single direction can be smaller than an effective Dk of the body in any other direction. In some embodiments, the effective Dk can be non-uniform in the single direction. The single direction can be a direction that travels through a short axis of the body. The effective Dk of the body is approximately in a range of about 1.01 to about 1.08.

The first skin surface and the second skin surface can be planar such that the first skin surface and the second skin surface lie substantially parallel to one another. The body can be configured to directly interface with one or more components of a radio frequency device to maintain conformance therewith. The body can be one or more of: (i) in contact but not affixed to the one or more components; (ii) affixed to the one or more components; or (iii) directly deposited onto the one or more components. In some embodiments, the body can be one or more of: (i) in contact but not affixed to the one or more components; or (ii) affixed to the one or more components. In some embodiments, the body can be configured to maintain an effective Dk normal to a surface of one or more of the first skin or the second skin.

The plurality of columns can be arranged in a honeycomb pattern having a plurality of cells disposed adjacent to one another. The body can have a compressive strength approximately in a range of about 6 MPa to about 30 MPa.

In some embodiments, the body can be configured to release the air therefrom upon lamination such that no more than about 10% of air gaps that existed prior to lamination continue to exist after lamination of the body. The body can be configured to withstand at least approximately 400 psi of pressure before breaking. The plurality of columns can include a plurality of gyroid structures.

In some embodiments, the structure can be configured to withstand a temperature of at least about 180 °C. One or more of the first skin surface or the second skin surface can include a metallic plated structure.

One exemplary method for manufacturing a radio frequency device includes additively manufacturing a foam for use with an antenna structure and directly interfacing the foam with one or more components of the antenna structure to maintain conformance therewith. The foam has a plurality of columns made up of mix of low-loss dielectric material and air, and a porous body that is anisotropic in a single direction.

Directly interface can further include one or more of: (i) maintaining in contact, but not affixing the foam to the one or more components; (ii) affixing the foam to the one or more components; or (iii) directly depositing the foam onto the one or more components. Directly interfacing can include laminating the foam to the one or more components. Laminating the foam to the one or more components can include releasing air from the foam such that no more than about 10% of air gaps that existed prior to lamination continue to exist after lamination.

A compressive strength of the laminated foam can be at least an order of magnitude higher than a compressive strength of the foam prior to lamination. The one or more components can include one or more of a ground plane, a microstrip line, or a patch to form a conformal microstrip fed patch antenna or a coplanar waveguide fed patch antenna.

The method can further include tuning one or more parameters of the foam to modulate an effective Dk of the foam. The one or more parameters can include at least one of a thickness, a density, or a height of the plurality of columns. The method can further include conforming the foam to the antenna structure to match a profile of the foam. In some embodiments, the method can further include attaching one or more skin layers to the foam. The method can further include designing the antenna structure with a portion of the volume of the antenna structure having a low effective dielectric constant and being made of a low-loss material.

Another exemplary embodiment of the lattice structure includes a foam spacer having an open-celled body that includes a mix of low-loss dielectric material and air. The body is anisotropic in a single direction.

The foam spacer can be capable of being disposed within a cavity of an antenna without being associated with a skin layer. The body can include a low effective Dk in the single direction normal to a curve of the profile of the body.

### BRIEF DESCRIPTION OF THE DRAWINGS

This disclosure will be more fully understood from the following detailed description, taken in conjunction with the accompanying drawings, in which:

FIG. 1 is a perspective view of a gyroid structure for use in forming some structures of the present disclosure and a perspective view of a solid, rectangular prism structure having a corresponding effective dielectric constant (Dk) value as the gyroid structure;

FIG. 2 illustrates perspective views of three gyroid structures, each structure having a different effective Dk realized through different wall thicknesses for each gyroid structure;

FIG. 3A is cross-sectional view of a foam structure having a gyroid geometry sandwiched between two thin solid layers;

FIG. 3B is a cross-sectional view of the foam structure having a gyroid geometry sandwiched between two thin solid layers of FIG. 3A, the foam structure now including plated geometries on a first layer and a second layer, and also having a plated through hole;

FIG. 4 is a perspective view of one embodiment of a planar anisotropic foam structure of the present embodiments;

FIG. 5A is a perspective view of one embodiment of a conformal anisotropic foam structure of the present embodiments;

FIG. 5B is a perspective side view of one embodiment of the conformal anisotropic foam structure of FIG. 5A;

FIG. 5C is a perspective bottom view of one embodiment of the conformal anisotropic foam structure of FIG. 5A;

FIG. 5D is a perspective top view of one embodiment of the conformal anisotropic foam structure of FIG. 5A;

FIG. 6A is a perspective view of one embodiment of a planar anisotropic foam structure having a honeycomb structure without a top skin layer;

FIG. 6B is a perspective view of the planar anisotropic foam structure of FIG. 6A having the top skin layer;

FIG. 7A is a schematic perspective view of a prior art coaxial probe feeding antenna;

FIG. 7B is a schematic perspective view of a prior art microstrip line feeding antenna;

FIG. 7C is a schematic perspective view of a prior art proximity coupled feeding antenna;

FIG. 7D is a schematic perspective view of a prior art coplanar wave guide feeding antenna;

FIG. 8A is a schematic perspective exploded view of a stack-up of the prior art proximity coupled fed patch antenna of FIG. 7C;

FIG. 8B is a schematic perspective exploded view of a stack-up of a prior art aperture coupled fed patch antenna;

FIG. 8C is a schematic perspective exploded view of a stack-up of a prior art common microstrip fed patch antenna;

FIG. 9A is a perspective exploded view of a conformal microstrip fed patch antenna of the present embodiments assembled from the conformal anisotropic foam structure of FIGS. 5A-5D;

FIG. 9B is a top perspective view of the conformal microstrip fed patch antenna of FIG. 9A;

FIG. 9C is a bottom perspective view of the conformal microstrip fed patch antenna of FIG. 9A;

FIG. 10A is a perspective exploded view of a coplanar waveguide fed patch antenna of the present embodiments assembled from the planar anisotropic foam structure of FIG. 4;

FIG. 10B is a top exploded view of the coplanar waveguide fed patch antenna of the present embodiments assembled from the conformal anisotropic foam structure of FIGS. 5A-5D

FIG. 10C is a top perspective view of the coplanar waveguide fed patch antenna of FIG. 10B;

FIG. 11A is a perspective view of one embodiment of an open-celled foam spacer of the present embodiments;

FIG. 11B is a perspective view of an alternate embodiment of an open-celled foam spacer of the present embodiments;

FIG. 11C is a perspective view of another alternate embodiment of an open-celled foam spacer of the present embodiments;

FIG. 11D is a perspective view of still another alternate embodiment of an open-celled foam spacer of the present embodiments;

FIG. 12A is a perspective view of an example embodiment of a cavity backed antenna foam spacer having the foam spacer of FIG. 11D disposed in a cavity in a ground plate without a printed circuit board (PCB);

FIG. 12B is an exploded perspective view of the cavity backed antenna foam spacer of FIG. 12A with a PCB layer;

FIG. 12C is a perspective view of an assembled cavity backed antenna foam spacer of FIG. 12B with the PCB layer;

FIG. 13 is a perspective view of an example embodiment of a passive radio frequency (RF) device of the present embodiments in the form of a spherical lattice;

FIG. 14A includes perspective views of exemplary embodiments of antennas and arrays to which the AMDFs of the present embodiments can be applied;

FIG. 14B includes perspective views, a schematic top view (switched beam array 814), and a top view (Vivaldi antenna 816) of additional exemplary embodiments of antennas and arrays to which the AMDFs of the present embodiments can be applied;

FIG. 14C includes perspective views and a top view (bowtie antenna 820) of additional exemplary embodiments of antennas and arrays to which the AMDFs of the present embodiments can be applied;

FIG. 15A includes perspective views of exemplary embodiments of lenses that can be formed from the AMDFs of the present embodiments;

FIG. 15B includes perspective views of exemplary embodiments of lenses that can be formed from the AMDFs of the present embodiments;

FIG. 16 is a perspective view of an embodiment of a constant-K lens of the present embodiments paired with a Vivaldi antenna;

FIG. 17 is a perspective view of exemplary embodiments of radomes that can be formed from the AMDFs of the present embodiments;

FIG. 18A is a perspective view of one embodiment of a printing apparatus that can be used to print the structures of the present disclosure, and thus the objects that include the structures of the present disclosure; and

FIG. 18B is a side view of the printing apparatus of FIG. 13A having a side panel of a housing removed to illustrate components of the printing apparatus disposed within the housing.

### DETAILED DESCRIPTION

Certain exemplary embodiments will now be described to provide an overall understanding of the principles of the structure, function, manufacture, and use of the devices and methods disclosed herein. One or more examples of these embodiments are illustrated in the accompanying drawings and/or are described herein. Those skilled in the art will understand that the devices and methods specifically described herein and illustrated in the accompanying drawings are non-limiting exemplary embodiments and that the scope of the present disclosure is defined solely by the claims. The features illustrated or described in connection with one exemplary embodiment may be combined with the features of other embodiments. Such modifications and variations are intended to be included within the scope of the present disclosure. Terms commonly known to those skilled in the art may be used interchangeably herein, including but not limited to additive manufacturing and 3D printing. Moreover, to the extent the term “antenna” is used in this specification, the term is meant to provide an example of a radiofrequency (RF) device, and that a person skilled in the art will recognize that the teachings with respect to the antenna can apply to other RF devices, as well as other systems and components such as radomes, lenses, waveguides, filters, dielectric resonators, and impedance matching layers.

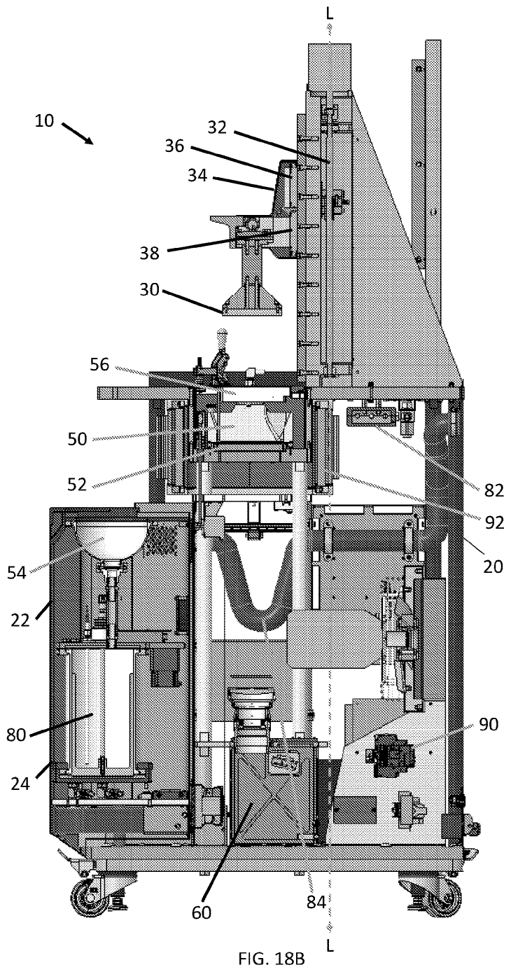

Because a person skilled in the art will generally understand how stereolithography (SLA), masked stereolithography (MSLA), and digital light processing (DLP) additive manufacturing works, the present disclosure does not provide all details related to the same. A person skilled in the art will understand how to produce the structures and objects provided for herein using vat polymerization procedures, including but not limited to SLA, MSLA, and DLP processes and SLA, MSLA, and DLP printers. Some non-limiting examples of DLP printers and techniques with which the present disclosures can be used include those provided for in U.S. Pat. No. 10,703,052, entitled “Additive Manufacturing of Discontinuous Fiber Composites Using Magnetic Fields,” U.S. Pat. No. 10,732,521, entitled “Systems and Methods for Alignment of Anisotropic Inclusions in Additive Manufacturing Processes,” and the FLUX 3D printer series, including the FLUX ONE and FLUX CORE 3D printers, manufactured by 3DFortify Inc. of Boston, MA (further details provided for at http://3dfortify.com/and related web pages), the contents of all being incorporated by reference herein in their entireties. Additional disclosures about a non-limiting embodiment of a DLP printer are provided with respect to FIGS. 18A and 18B herein.

The present disclosure generally relates to the creation of Additive Manufacture Dielectric Foams (AMDFs) using additive manufacturing techniques, such as vat polymerization (e.g., DLP). A person skilled in the art will recognize that the teachings with respect to the use of DLP to make AMDFs will also apply to other forms of additive, including FFF (fused filament fabrication) and various forms of powder bed fusion. The AMDFs are equivalent to and/or better than traditional foam cores used in radio frequency (RF) devices, such as antenna. This is at least because they better withstand crushing and high temperatures when being laminated, and because they can be configured to have more versatility, such as being able to have DC connectivity and be made into a wider variety of shapes and sizes than RF devices utilizing traditional foam cores. The AMDFs of the present embodiments can include anisotropic lattice embodiments such that waves can experience a lower Dk when traversing the AMDF in a specific direction. The anisotropic AMDFs can be planar and/or conformal, and can include a plurality of skins having a plurality of columns therebetween. In some embodiments, the skins can be metallic plated structures having the columns disposed therebetween. Tuning of a thickness, density, and/or height of the columns can modulate the effective Dk and a cutoff frequency of the AMDF. The AMDFs can interface or directly interface with the antenna in a variety of ways. This can include: (i) being in contact but not affixed to one or more components of the antenna; (ii) affixed to one or more components of the antenna; and/or (iii) directly deposited onto one or more components of the antenna (e.g., printed or laminated onto the one or more components). In some embodiments, the AMDF can include a scaffold having an open-celled structure that can be disposed in a cavity of a ground plate to form a cavity backed antenna foam spacer. For the purposes of this disclosure, the components of the antenna can include a ground plane, a microstrip line, a feed substrate, and/or a patch, among others.

AMDFs as provided for herein can have various design features. In some embodiments, the AMDFs can be 3D-printed, quasi-solid bricks made from a low electrical loss tangent photopolymer. The main body of such an embodiment of the AMDF can be a mechanical structure printed with a mix of dielectric material and air in a format that optimizes between a very low effective relative permittivity and a high mechanical strength. The dielectric/air mix can be achieved using a number of structures, including a repeating gyroid pattern. In some embodiments, an effective relative permittivity rate of the structure can be approximately in the range of about 1.08 to about 1.3. A relative permittivity as low as about 1.1 for low RF performance can be achieved by the present disclosures, and a relative permittivity as low as about 1.08 for higher military radar frequencies can be achieved by the present disclosures. However, this metric is a trade-off with mechanical strength, so a higher relative permittivity can allow for a higher strength device.

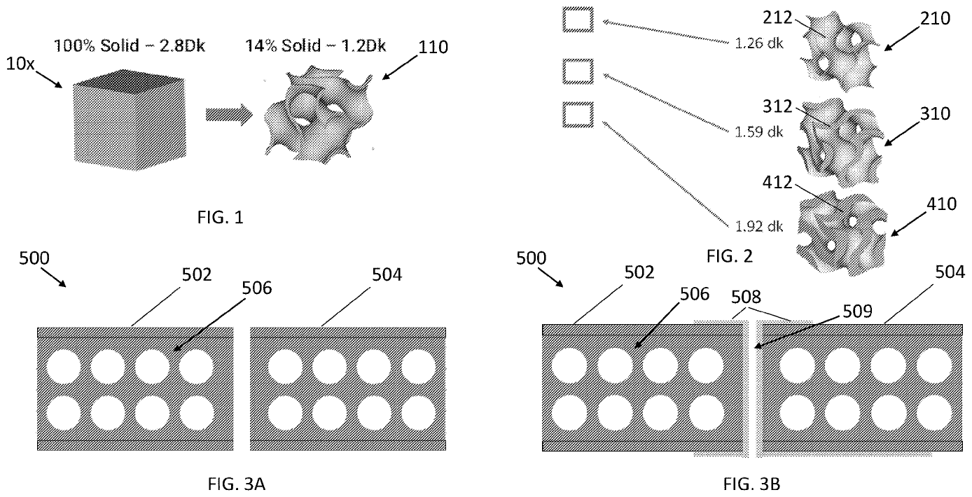

FIG. 1 illustrates one exemplary embodiment of a gyroid structure 110 used to form at least some embodiments of an AMDF. As shown, the gyroid structure 110 is about 14% solid and has a Dk value of about 1.2 Dk. By way of comparison, a solid, rectangular prism structure 10x is provided, is 100% solid, and has an effective Dk value of about 2.8 Dk. An effective dielectric value of the structures that are part of the present disclosures can be approximately in the range of about 1.1 Dk to about 2.2 Dk, and in some embodiments can be at least about 2.8 Dk, thus allowing for an approximate range of about 1.1 Dk to about 2.8 Dk.

FIG. 2 provides three gyroid structures 210, 310, 410, each having different configurations, resulting in each having a different Dk value. Changing a wall thickness of the respective gyroid patterns of the structures 210, 310, 410 can increase or decrease the effective Dk value of that region. More particularly, as shown, the structure 210 has walls 212 having a thickness that is less than a thickness of walls 312 of the structure 310, which themselves have a thickness that is less than a thickness of walls 412 of the structure 410.

Even in the same gyroid structure, some walls may have different thicknesses and/or thickness that varies across a length and/or width of a wall. The ability to control certain portions of an object being printed to have different dielectric constants across its surface area, layers, volume, etc. can be useful in providing a more finely tuned, capable, and versatile device. Additional information about printing RF devices using gyroid structures is provided for at least in U.S. patent application Ser. No. 17/274,406, entitled “Systems and Methods for Designing and Manufacturing Radio Frequency Devices,” filed Apr. 13, 2022, and the contents of which is incorporated by reference herein in its entirety.

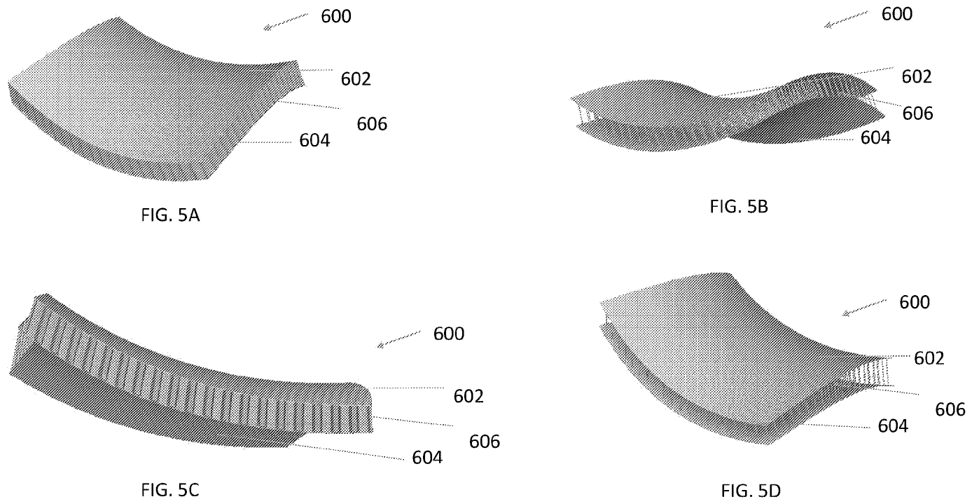

FIG. 3A illustrates the cross section of a AMDF 500 formed by structures like the gyroid structures 210, 310, 410, showing a thin solid layer 502, 504 above and below a thin-walled gyroid pattern 506 creating a stage for copper plating separated by a low effective Dk. The horizontally illustrated portion of FIG. 5A reflects traces and a patch antenna. FIG. 3B shows the AMDF 500 having a plated hole 509 and plated copper 508 applied to the structure, i.e., the AMDF 500.

AMDFs of the present embodiments are not limited to being formed from gyroid structures. For example, alternate lattice embodiments that can be used to form AMDFs can include structures that are designed to lack isotropicity of specific properties, e.g., having a non-uniform Dk value in a certain direction, while having a mix of air and dielectric materials. Use of anisotropic foam structures can reduce the Dk lower than that of the gyroid structures described above. A Dk value of the anisotropic structures of the present embodiments can be approximately in a range of about 1.01 to about 1.08, which is about 15% or more of a reduction in effective Dk than that of the gyroid structures 210, 310, 410. While the present embodiments are discussed with respect to a lower Dk value in a z-direction, it will be appreciated that in some embodiments, the lower Dk value can occur in one of the x-direction and/or the y-direction.

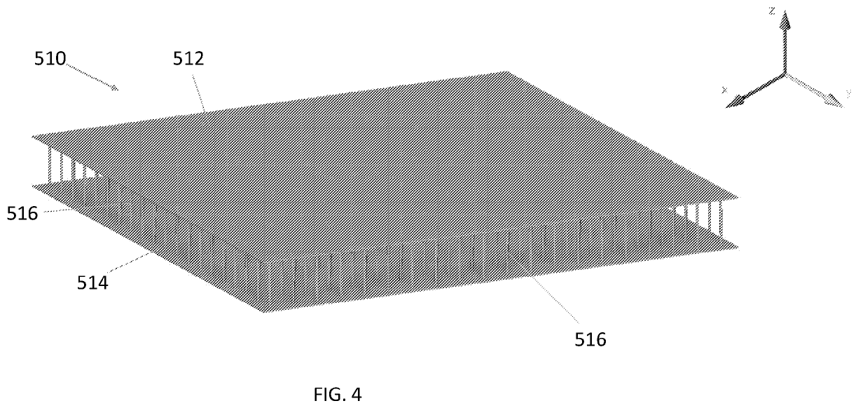

FIG. 4 illustrates an exemplary embodiment of such an anisotropic foam structure or AMDF 510 having a specific Dk in a z-direction. The foam structure 510 can include a planar geometry such that layers of the foam can lie substantially parallel to one another. As shown, the foam structure 510 can include a top skin 512 disposed at a first end and a bottom skin 514 disposed at a second end, and an array of pillars or columns 516 disposed therebetween. The foam structure 510 is oriented such that when waves, e.g., electromagnetic waves, traverse laterally through this foam structure 510, e.g., in the x-direction, they experience a different, e.g., larger, effective Dk than waves traveling through the short axis of the body, e.g., in the z-direction. That is, the foam structure 510 can be oriented such that periodicity of these electromagnetic waves can be normal to a surface of the foam structure 510 rather than tangent to a surface thereof. The ability to have programmed anisotropy in normal and tangent planes can allow for additional degrees of freedom when designing the AMDFs 510. This ability can allow for performance to be tuned regardless of the geometry, which is an advantage over traditional isotropic unit cell foams. Changing or tuning one or more parameters of the foam structure 510 can modulate one or more of the effective Dk and/or the cutoff frequency. Some non-limiting examples of such parameters can include column thickness, density, spacing, and/or height, among others. The ability to tune the foam structure to a specific Dk can allow antenna designers to create and/or implement any antenna design from scratch without being wed to a preexisting design.

In conventional nonplanar foams, parts are commonly machined to shape to fit to unique antenna shapes, while the foam structures of the present embodiments do not have this limitation. FIGS. 5A-5D illustrate an alternate embodiment of an anisotropic foam structure or AMDF 600 that is configured to bend or flex in one or more directions. As shown, the skins or panels 602, 604 can be “warped,” “twisted,” or “conformed” to match any shape, while maintaining a designed effective Dk normal to a surface of the skin 602, 604 that can include the columns 606 disposed therebetween. For example, in some embodiments, the AMDF 600 can be transitioned from a first configuration, e.g., having a planar geometry similar to that of the AMDF 510 in FIG. 4, to a second configuration, e.g., a warped configuration, in which the skins 602, 604 can become warped or bent to match a specific shape or outline. Conformance can be desired, for example, when an antenna is designed to be conformed to a device surface, and the foam structure 600, e.g., a conformal foam, can be used to match that profile. In some embodiments, the foam structure 600 can sit below the surface of a fuselage to serve as an antenna substrate that can bend to accommodate a particular shape of the antenna. It will be appreciated that, in some embodiments, the AMDF 600 can include a skin that has a conformal geometry, e.g., 602, 604 and another skin that has a planar geometry, e.g., 512, 514.

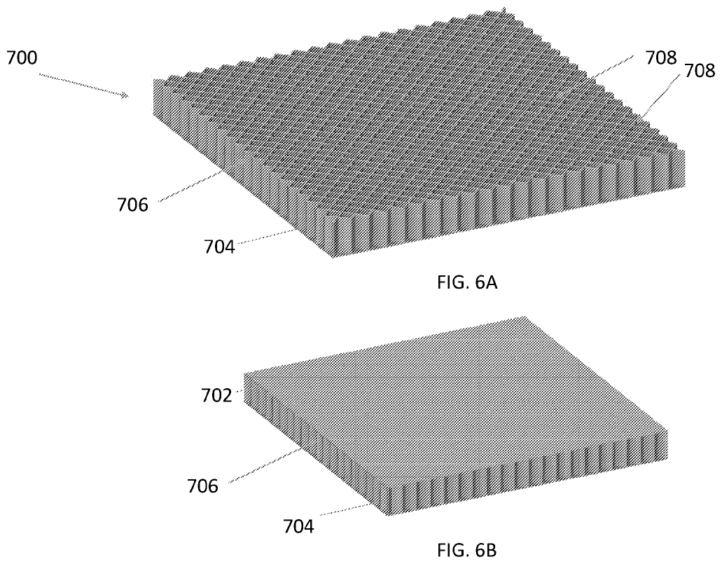

FIGS. 6A-6B illustrate an alternate embodiment of a foam structure 700 that can include a top skin 702 disposed at a first end, a bottom skin 704 disposed at a second end, and a network of honeycomb pillars 706 disposed therebetween. The honeycomb 706 can be made up from a plurality of cells or rooms 708 arranged in a honeycomb pattern. The honey comb 706 can provide for additional stability while still being able to be conformal.

The foam structures 510, 600, 700 of the present embodiments can be applied to several feed techniques used for patch antennas to provide superior results as compared to conventional foams. Feed techniques for an antenna can be classified into two categories: contacting and non-contacting. In the contacting method, the radiofrequency (RF) power can be fed directly to a radiating patch using a connecting element such as a microstrip line and/or a coaxial probe. In the non-contacting scheme, electromagnetic field coupling can be used to transfer power between the microstrip line and the radiating patch, resulting in aperture coupling and/or proximity coupling. A more detailed description of each of these conventional feed techniques is presented below for reference.

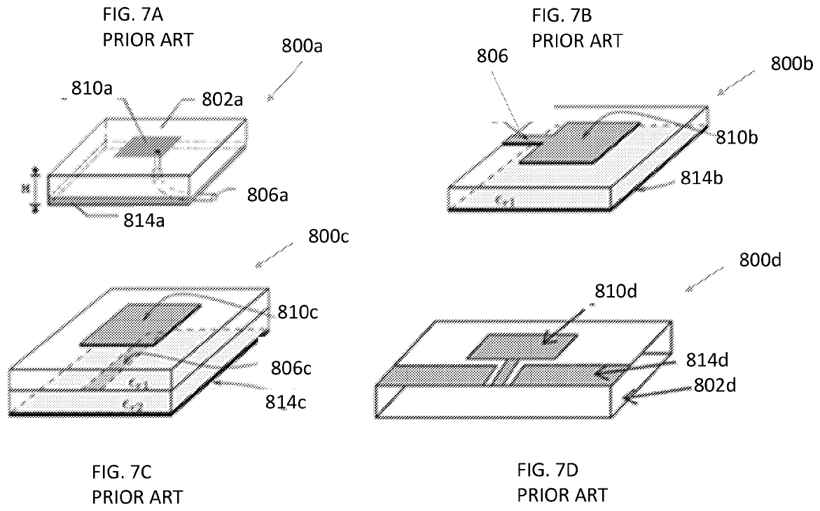

FIGS. 7A-7D illustrate exemplary conventional configurations for feeding antennas that are known in the art. As shown, coaxial probe fed 800a (FIG. 7A), microstrip line fed 800b (FIG. 7B), proximity coupled fed 800c (FIG. 7C), and coplanar wave guide fed 800d (FIG. 7D) can differ in their respective arrangements of a patch 810a, 810b, 810c, 810d, a substrate 802a, 802d, and/or a ground plane 814a, 814b, 814c, 814d within their respective feed techniques. Each configuration of the feeding antenna 800a, 800b, 800c, 800d can present a varying feed technique that presents unique properties that may offer advantage over other configurations. For example, in the microstrip line feed 800b of FIG. 7B, a conducting strip 806b can be directly connected to an edge of a microstrip patch 810b. The microstrip line feed 800b can be etched on the same substrate, as shown, to provide a planar structure. Properties of the remaining configurations for these conventional configurations for feeding antennas are known by one skilled in the art and/or understood based on the labeling of the components in FIGS. 7A-7D, and a detailed discussion of such properties is omitted herein for the sake of brevity.

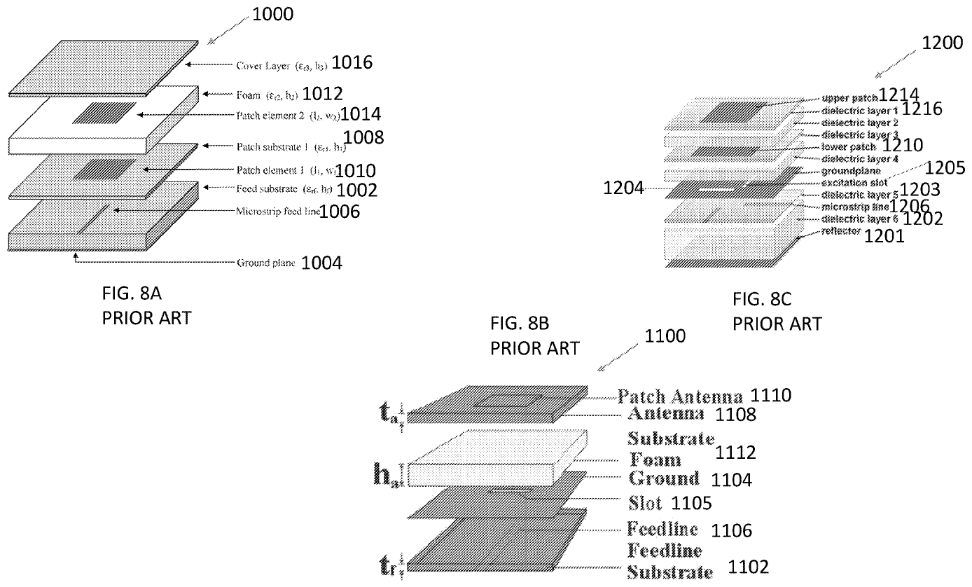

Representative arrangements of some of these antenna types can be shown in the exploded views of the stack-ups of FIGS. 8A-8C, for example. As shown, a conventional proximity coupled patch antenna 1000 can include a feed substrate 1002 having a ground plane or ground plate 1004 with a microstrip line 1006 formed therein. A patch substrate 1008 having a patch element 1010 can be disposed above the feed substrate 1002. A foam layer 1000 having a second patch element 1014 can be disposed above the patch substrate 1008 with a cover layer 1016 disposed thereon.

FIG. 8B illustrates a conventional aperture coupled patch antenna 1100 can include a feed substrate 1102 having a feedline 1106 formed therein. A ground plane or ground plate 1104 having a slot 1105 formed therein can be disposed above the feed substrate 1102. A foam layer 1112 can be disposed above the ground plane 1104 with an antenna substrate 1108 having a patch antenna 1110 disposed above the foam layer 1112.

FIG. 8C illustrates a conventional microstrip patch 1200 that includes a reflector 1201 having a first dielectric layer 1202 disposed thereon. A second dielectric layer 1203 having a microstrip line 1206 formed thereon can be disposed above the first dielectric layer 1202. A ground plane 1204 having a plurality of excitation slots 1205 formed therein can be stacked above the second dielectric layer 1203. As shown, four additional dielectric layers can be stacked above the second dielectric layer 1203, with one or more of said additional dielectric layers having a patch element associated therewith 1210. A top dielectric layer 1216 of the four additional dielectric layers can include a second patch element 1214 associated therewith.

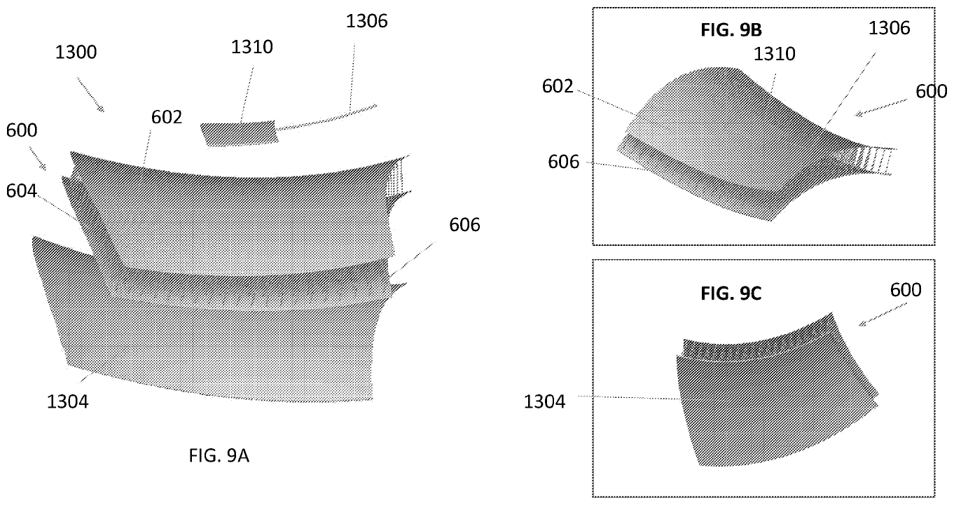

FIGS. 9A-9C illustrate the foam structure 600 of FIGS. 5A-5D substituted into a stack-up similar to that of microstrip line feeding antenna 800 of FIG. 7B, for example, to form a conformal microstrip fed patch antenna 1300. As shown, the AMDF 600 can be used in lieu of a foam layer, with the AMDF 600 having a microstrip line 1306 in communication with a patch 1310 disposed thereon. The AMDF 600 can conform to a surface of the ground plane 1304 such that the AMDF 600 can continue to conform to the ground plane 1304 despite any warping, twisting, and/or manipulation thereof, as shown in FIGS. 9B-9C.

The components of the conformal microstrip fed patch antenna 1300, e.g., the ground plane 1304, the microstrip line 1306, and/or the patch 1310 can interface or directly interface with the AMDF 600 in a variety of ways. As shown, the AMDF 600 can directly interface with the components of the conformal microstrip fed patch antenna 1300 to maintain conformance therewith. Some non-limiting examples of direct interface supported by this disclosure can include the AMDF 600 being: (i) in contact, but not affixed to the components; (ii) affixed to the components; and/or (iii) directly deposited onto the components. Regardless of the type of interface, the AMDF 600 can conform to these components. Direct interface, for the purposes of this disclosure, can, but does not necessarily suggest a need to, form assembly contact between the AMDF 600 and the components and/or direct coupling to a surface of any of the ground plane 1304, the microstrip line 1306, and/or the patch 1310. In some embodiments, the AMDF 600 can be laminated to one or more of the components. A person skilled in the art will recognize that the technique of direct interface between the AMDF 600 and the each of the components can differ for each component. For example, in some embodiments, the AMDF 600 can be in direct contact with the ground plane 1304 while being affixed to the patch 1310. In some embodiments, direct interface between the AMDF 600 with the components of the conformal microstrip fed patch antenna 1300 can include the AMDF 600 being: (i) in contact, but not affixed to the components or (ii) affixed to the components, without being directly deposited onto the components. That is, in such embodiments, if the AMDF 600 is (i) in contact, but not affixed to the components or (ii) affixed to the components, then the AMDF is not directly deposited onto the components.

Moreover, the foam structures of the present embodiments have increased rigidity and compressive strength as compared to traditional foam structures that have challenges with heat pressure lamination. For the purposes of this disclosure, the foam structures of the present embodiments can have a compressive strength in approximately a range of about 6 MPa to about 30 MPa and/or at least 2 times more compressive than traditional foams. For example, as the instant foam structures are laminated, air gaps can more easily be eliminated therefrom, which further lowers the Dk of the resulting structures. That is, rather than compressing air gaps during lamination, the foam structures of the present embodiments can allow for elimination of the gaps, which can increase a compressive strength by at least one order of magnitude, and in some cases, at least two orders of magnitude, as compared to a traditional laminated foam structure and/or a foam structure prior to lamination. In some embodiments, air gaps can be eliminated such that no more than about 10% of air gaps that existed prior to lamination continue to exist after lamination of the foam structure of the present embodiments, and in some embodiments no more than about 5% of air gaps continue to exist.

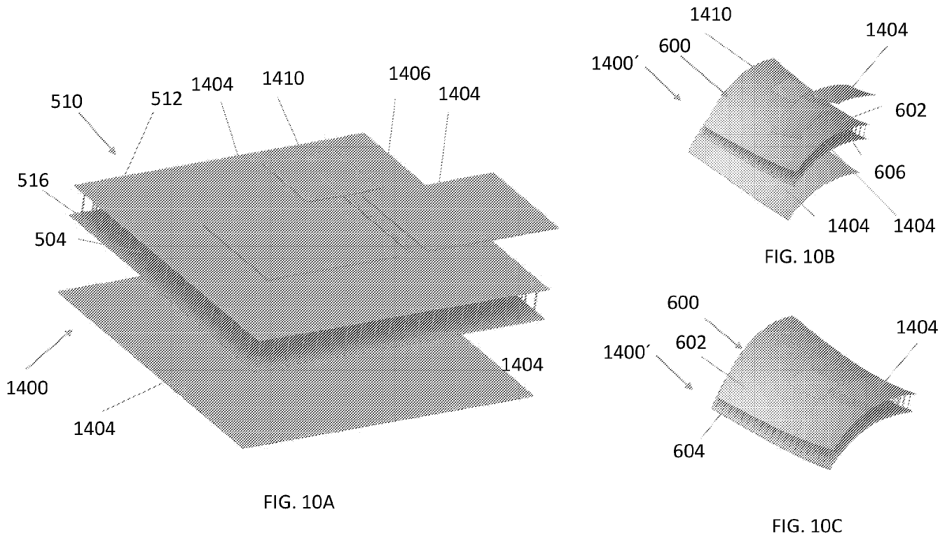

FIGS. 10A-10C illustrate a coplanar wave guide fed patch antenna 1400. As shown in FIG. 10A, the foam structure 510 of FIG. 4 can be substituted into the coplanar wave guide fed antenna of FIG. 7D to form the coplanar wave guide fed patch antenna 1400. The AMDF 600 can be used in lieu of a foam layer, with the AMDF 600 having a microstrip line 1406 in communication with a patch 1410 disposed thereon. In some embodiments, the foam structure 600 of FIGS. 5A-5D can be substituted into the coplanar wave guide fed antenna of FIG. 7D in lieu of the foam structure 510 to form a coplanar wave guide fed patch antenna 1400′, as shown in FIGS. 10B-10C. The AMDF 600 can conform to a surface of the ground plane 1404 such that the AMDF 600 can continue to conform to the ground plane 1304 despite any warping, twisting, or manipulation thereof, as shown in FIGS. 10B-10C.

The components of the coplanar wave guide fed patch antenna 1400, e.g., the ground plane 1404, the microstrip line 1406, and/or the patch 1410 can interface with the AMDF 510, 600 in a variety of ways. As shown, the AMDF 510, 600 can directly interface with the components of the coplanar wave guide fed patch antenna 1400 to maintain conformance therewith. Some non-limiting examples of direct interface supported by this disclosure can include the AMDF 510, 600 being: (i) in contact, but not affixed to the components, (ii) affixed to the components, and/or (iii) directly deposited onto the components. Regardless of the type of interface, the AMDF 510, 600 can conform to these components. Direct interface, for the purposes of this disclosure, can, but does not necessarily suggest a need to, form assembly contact between the AMDF 510, 600 and the components and/or direct coupling to a surface of any of the ground plane 1404, the microstrip line 1406, and/or the patch 1410. In some embodiments, the AMDF 510 can be laminated to one or more of the components. A person skilled in the art will recognize that the technique of direct interface between the AMDF 510, 600 and the each of the components can differ for each component. For example, in some embodiments, the AMDF 510, 600 can be in direct contact with the ground plane 1404 while being affixed to the patch 1410. In some embodiments, direct interface between the AMDF 510, 600 with the components of the coplanar wave guide fed patch antenna 1400 can include the AMDF 510, 600 being: (i) in contact, but not affixed to the components or (ii) affixed to the components, without being directly deposited onto the components. That is, in such embodiments, if the AMDF 510, 600 is (i) in contact, but not affixed to the components or (ii) affixed to the components, then the AMDF is not directly deposited onto the components.

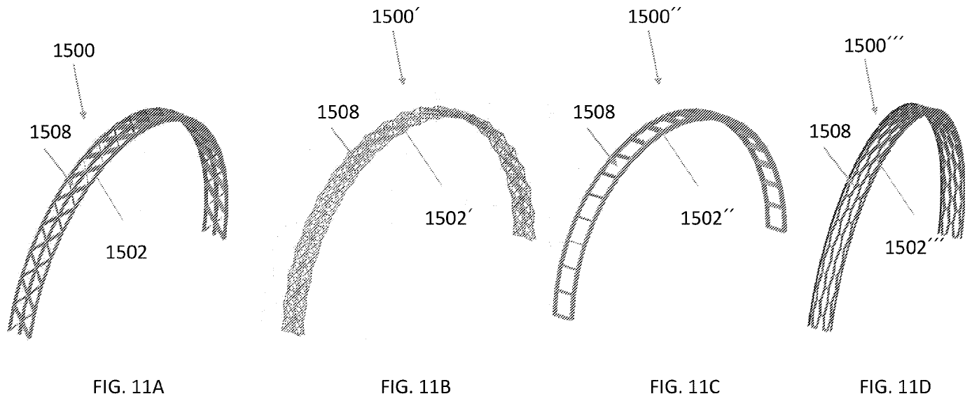

In some embodiments, the AMDF or foam structure can include a foam spacer or scaffold 1500. The scaffold 1500 can include a foam layer 1502 without top and/or bottom skin layers as shown in FIGS. 4, 5A-5D, and 6A-6B. FIGS. 11A-11D illustrate exemplary embodiments of the foam spacer 1500 that can conform to a ground plane, e.g., a conformal foam spacer, in a similar fashion as the embodiments discussed above. The foam layer 1502 can be formed from a plurality of open celled structures 1508 that are intertwined to make the body of the foam layer. Use of foam structures 1500 can reduce the Dk value to lower than that of the gyroid structures at least in a direction normal to a curve of the profile of the foam spacer 1500. It will be appreciated that the above discussion is also applicable to foam spacers 1500′, 1500″, 1500″′ of FIGS. 11B-11D.

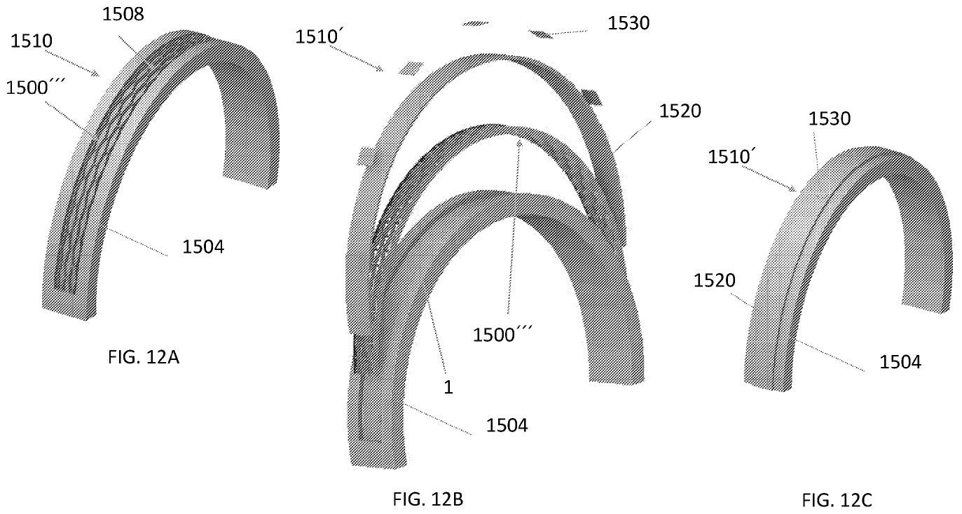

The foam spacer 1500 can be used with any of the stack-ups discussed in the present disclosure, as well as to fill cavities formed in one or more layers of a stack-up. For example, the ground plane or ground plate 1304, 1404 of an antenna can include a cavity 1, as shown in FIGS. 12A-12C, formed therein. The cavity 1 can be recessed into the ground plate 1504 (see FIGS. 12A-12C) such that a bore is formed through at least a portion of the ground plate 1504. As with the embodiments discussed above, the cavity 1 aims to be free from material, e.g., air, but some applications can place a supporting structure with a low Dk in the cavity to structurally support the rest of the antenna stack-up. For example, in such embodiments, a Dk of the scaffold 1500 is desired to be as near as possible to that of air, while mechanically supporting the antenna stack-up, e.g., a planar stack-up or a conformal stack-up, for example. This differs from conventional foams, e.g., flexible and/or compressible foams traditionally have manufacturing and/or assembly-related limitations, which can extend into perfromance related behaviors. For example, conventional foams can compress, which can change their effective Dk, thereby impacting device performance. The structure of the foam spacer 1500 aims to maintain the Dk as close as possible to that of air, which can eliminate air gaps, rather than compress them, thereby reducing the Dk of the overall structure as compared to convnetional foam spacers.

FIGS. 12A-12C illustrate an example embodiment of a cavity backed antenna foam spacer 1510. As shown, the cavity backed antenna foam spacer 1510 can include a foam spacer 1500″′ having open celled structures 1508 directly interfacing with a ground plate 1504. The ground plate can include a cavity 1 formed therein that is configured to receive the foam spacer 1500″′. In some embodiments, the foam spacer 1500″′ can be laminated or directly interface with the cavity 1 to be disposed therein. In some embodiments, the cavity backed antenna foam spacer 1510′ can include a PCB layer 1520 in a stack-up, as shown in FIG. 12B. The cavity backed antenna foam spacer 1510′ can include one or more conformal patches 1530 that directly interface with the PCB layer 1520, as shown in FIG. 12C.

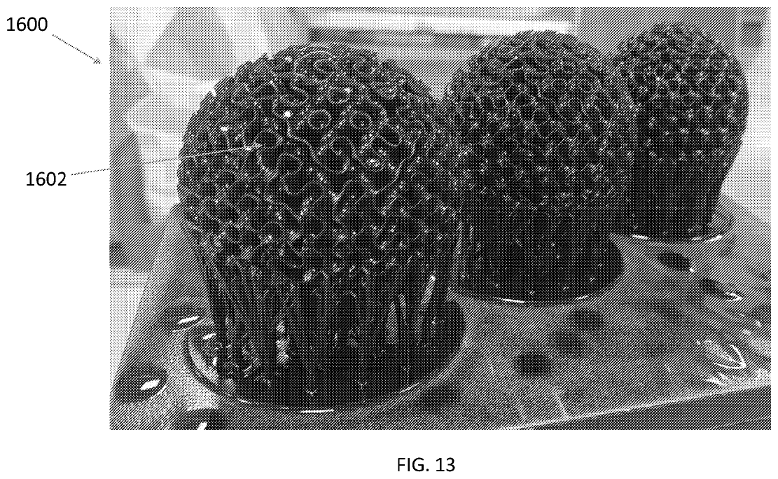

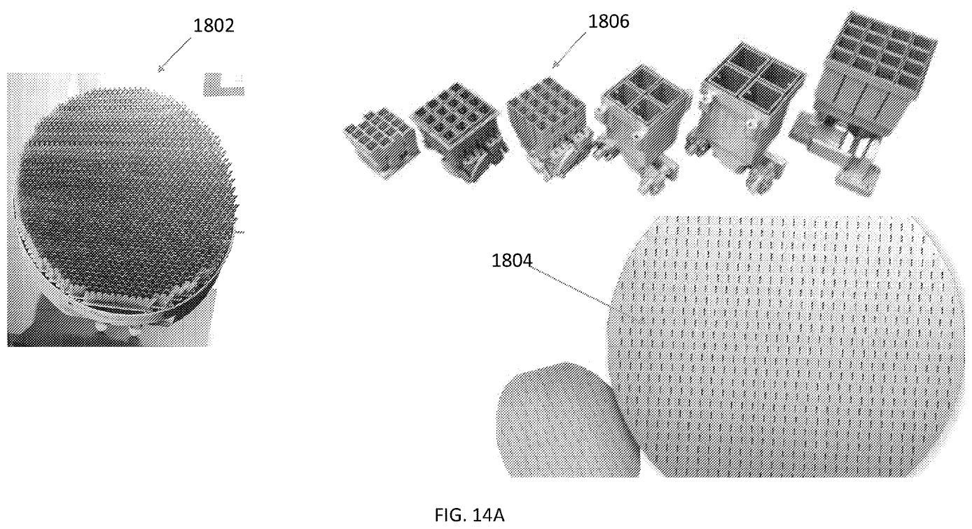

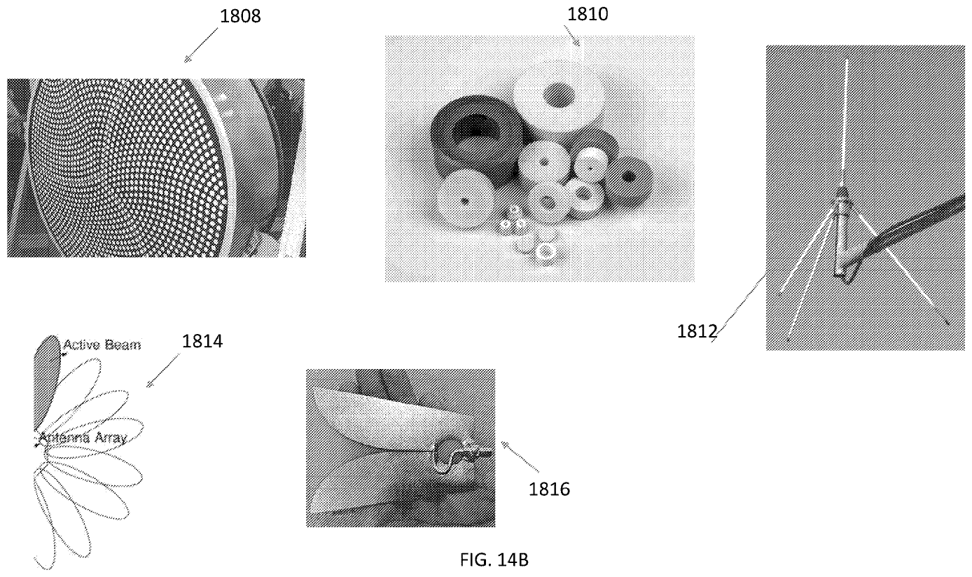

FIG. 13 illustrates an example embodiment of passive RF devices 1600 that can increase gain and/or directivity of an RF signal. Passive RF devices 1600 can be implemented in focusing lenses, e.g., Luneburg lenses, dispersing lenses, e.g., fisheye, and/or waveguide, horn, and/or patch antennas. Moreover, these passive RF devices 1600 can reasonably be achieved for X, Ku, or Ka band (limited by device and/or feature size). As shown, such passive RF devices 1600 can take the form of a spherical lattice and/or hemisphere with paths 1602 formed in the surface thereof. Advantages of the passive RF devices 1600 can include that these devices are non-metallized, can be retrofit to existing designs, exhibit high gain increase and steering, and/or experience passive gain (lower power amplifiers, no increase in signal/noise ratio (S/N), less elements per array).

While the foam structures of the present embodiments are discussed herein as serving as substrates, a person skilled in the art will recognize that the foam structures can be superstrates and/or makeup other layers of the stack-ups of the antenna feeds.

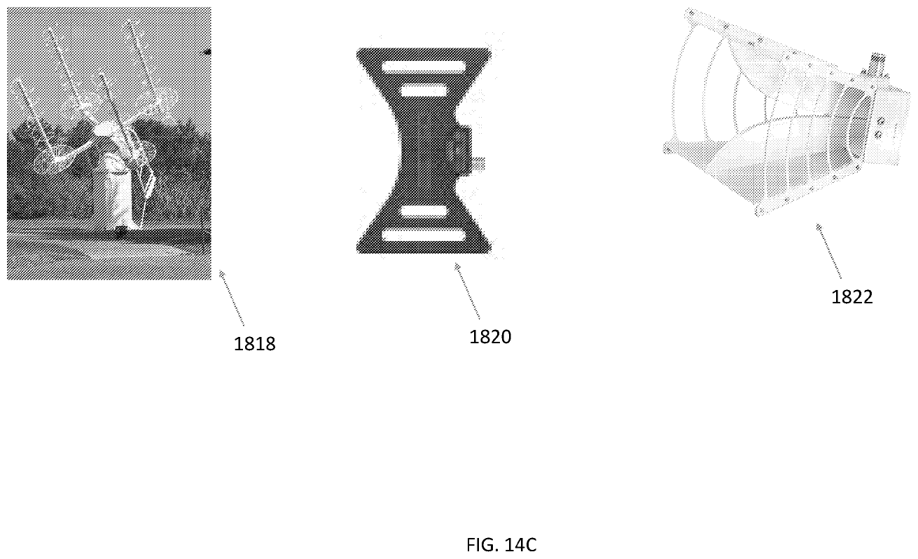

The AMDFs of the present embodiments can be used in conjunction, e.g., be paired, with a wide variety of antennas. For example, some non-limiting examples of antennas that can be addressed with the AMDFs of the present embodiments are shown in FIGS. 14A-14C. These can include, by way of non-limiting examples: image active electronically scanned arrays (AESAs) 1802; waveguide phased array antennas, such as slotted waveguide phased array antennas 1804; horn arrays and/or horn phased arrays 1806; phased arrays, such as active phased arrays 1808; dielectric resonators 1810; monopoles/dipoles 1812; switched beam arrays 1814; and/or wideband antennas (such as Vivaldi antennas 1816, spiral antennas 1818, bowtie antennas 1820, dual ridged horn antennas 1822, and/or arrays combining one or more of the same,. In some embodiments, the AMDFs can be applied to any of the above antennas as an array to provide one or more advantages, such as those provided for herein or otherwise understood by a person skilled in the art in view of the present disclosures. The AMDFs of the present embodiments can be applied to any of these types of antennas and/or arrays illustrated in FIGS. 14A-14C, as well as other antenna, arrays, etc. known to those skilled in the art, by a person skilled in the art in view of the present disclosures. Moreover, a person skilled in the art will appreciate the functions, operations, configurations, and details, e.g., shapes and/or construction, of the antennas and/or arrays discussed herein, and thus a detailed discussion of the same is omitted herein for the sake of brevity.

For example, with respect to active phased arrays 1808, the AMDFs of the present embodiments can mimic, or behave similarly to, one or more properties of an artificial dielectric to exhibit one or more properties thereof. An example of such an advantage is that anisotropic dielectrics can be built by simply stacking layers of different homogeneous materials with sub-wavelength thickness. An artificial anisotropic material can therefore be realized stacking two different materials along the z-direction (i.e., normal to the material surface), which are characterized by two different permittivities and thicknesses to form a unit cell that is repeated in one dimension. The techniques of the present embodiments can be leveraged to additively manufacture the AMDFs having this advantage. For example, the Dk of the AMDFs can be varied across a volume thereof to create an anisotropic structure in a given direction by way of a geometry of the AMDF, as discussed further below.

The antennas and/or arrays discussed above can be augmented in a variety of ways. One example of the more complex shapes supported by the AMDFs of the present embodiments can include the curved shapes of lens or a lens antenna that is paired with the antenna embodiments discussed above to create an AMDF that is spaced equidistantly, or substantially equidistantly, from the curved lens for maximum performance, or even a curved AMDF that is changing its distance from the lens or antenna based on x/y axes position to provide different augmentation and/or impedance matching at different portions of a beam or scan angle. Additional benefits of configurations provided for herein can include increase gain, reduce side lobes, improve field of view, and/or provide the same performance with few power requirements, as examples. In some embodiments, the lenses can be objects that can be placed in front of a generated beam to enhance and/or manipulate a strength of the beam. The lenses of the present embodiments can be wideband to allow for pairing with one or more of the antenna embodiments discussed above. One exemplary embodiment of such a lens can include a gradient refractive index (GRIN) dielectric lens or GRIN lens 1850. GRIN dielectric lens (or lens antenna) 1850 is a type of dielectric metastructure with a continuous spatially graded index of refraction, which can allow for some control of the electromagnetic radiation passing through the structure. In short, GRIN dielectric lenses/antennas 1850 can be used to greatly alter the performance of an antenna by modifying/augmenting the gain, directivity, antenna pattern, steering angle, bandwidth, and/or other key antenna parameters. The wideband GRIN lenses of the present embodiments may be able to be used in conjunction, e.g., be paired, with wideband antennas to provide wide-angle impedance matching, beam focusing, and/or beam steering. In at least some instances, this may require many matching layers to achieve broad bandwidth in a dielectric-only approach, which may be achievable in view of the present disclosures and knowledge of a person skilled in the art. The GRIN lenses 1850 of the present embodiments can be used in military/defense, aerospace/space, commercial 5G telecommunications, satellite communications (SATCOM), and/or various sensor applications. Additional aspects and features of GRIN lenses are understood by a person skilled in the art, and thus they are not included for brevity. A person skilled in the art, in view of the present disclosure, will understand how the superstrates provided for herein can be used in conjunction with many varieties of GRIN lenses.

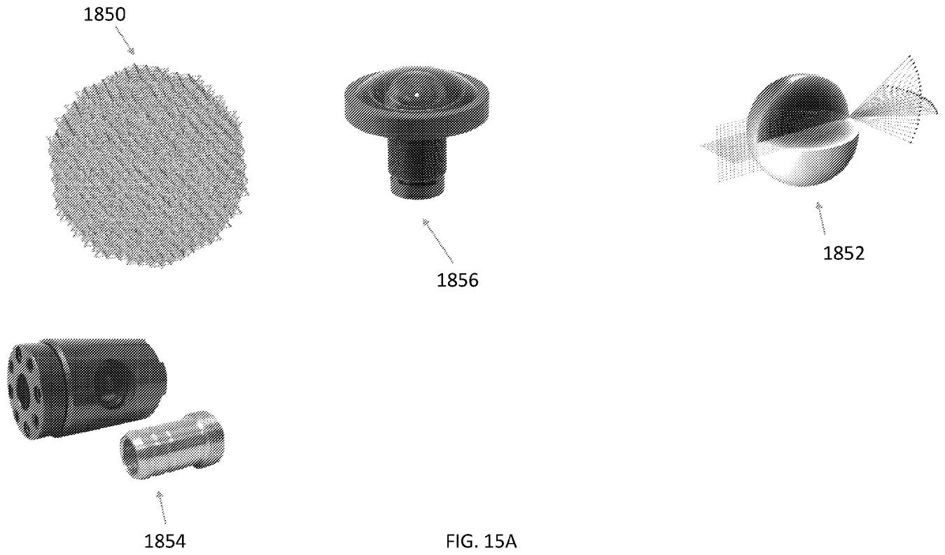

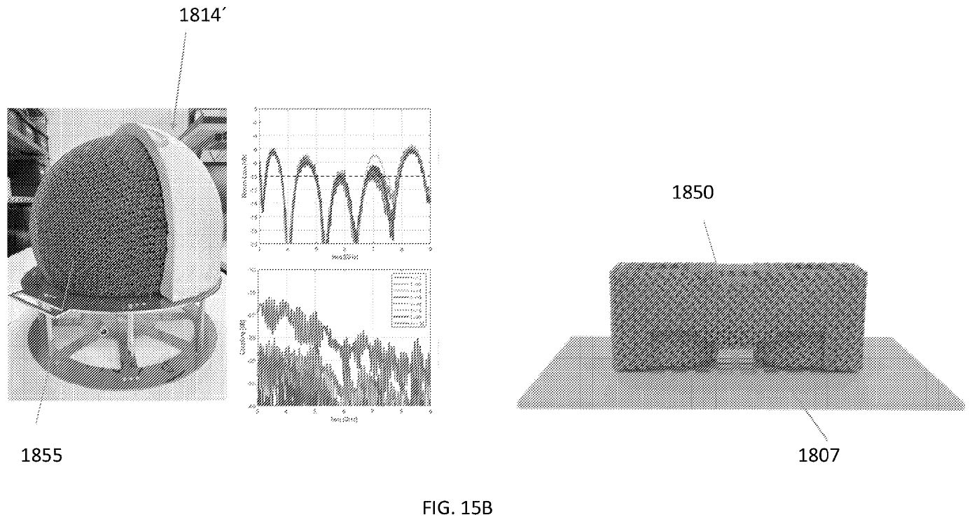

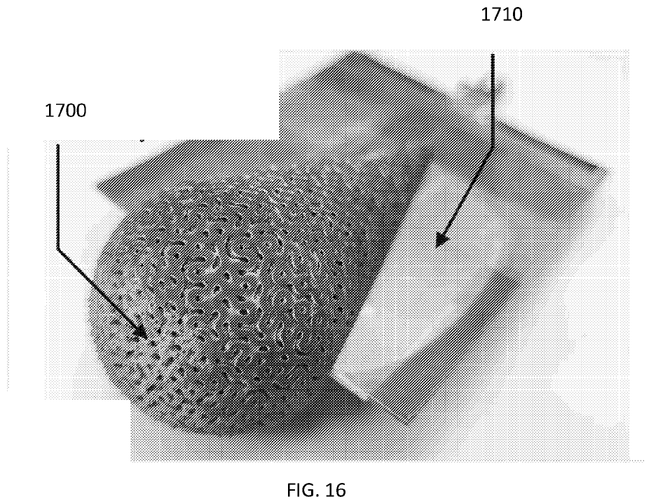

The techniques of the present embodiments can allow for cost-effective fabrication of complex GRIN lenses. For example, the AMDFs disclosed above can be printed as extremely intricate and high resolution GRIN lenses 1850 that operate well at microwave/mm-wave frequencies. These lenses, which are extremely difficult to manufacture using traditional methods, can provide substantial antenna gain in a relatively compact shape and with minimal weight. Some non-limiting examples of GRIN lenses that can be manufactured with the techniques of the present embodiments can include: field of view enhancing lenses; Luneburg lenses 1852; dispersive lenses; focusing lenses; beam splitting lenses 1854; multi-beam lenses; switched beam antenna lenses; Maxwell fisheye lenses 1856; compressed lenses; quasi transformation optics based lenses; cylindrical lenses; low-profile lenses; aperture lenses; constant-K lenses 1700 (shown in FIG. 16); and/or sidelobe reducing lenses, among others, some non-limiting examples of which are shown in FIG. 15A. The AMDFs of the present embodiments can be applied to any of these types of lenses by a person skilled in the art in view of the present disclosures.

It will be appreciated that the shape of the AMDFs of the present embodiments can deviate from that of the AMDFs shown in the present figures to accommodate a shape of the array that is addressed. As mentioned above, customizability of a parameter such as shape can be performed with far more control on the AMDFs of the present embodiments than on conventionally manufactured foams. By way of further example, FIG. 15B provides for a shape of a printed lens 1855, as shown a Luneburg lens, on a switched beam array 1814′ and a lens 1850 of the phased array 1807 where AMDFs of the present disclosure can be used that would differ from traditional foams. In the illustrated embodiment, the superstrates are used, but a person skilled in the art, in view of the present disclosures, will understand that AMDFs as provided for herein can be used in lieu of the illustrated superstrates. Additional information about superstrates are provided for in a counterpart application filed on an even date herewith entitled “Low-Loss Dielectric Lattice-Based Superstrates and Methods for Producing the Same,” the content of which is incorporated by reference herein in its entirety. In the illustrated embodiments, each of the lens 1855 of the switched beam array 1814′ and the lens 1850 of the phased array 807 are printed using superstrates of the aforementioned patent application that is incorporated by reference. More particularly, the embodiments of FIG. 15B were printed using Radix™ printable dielectric material (e.g., 2.8 Dk), provided by Rogers Corporation (Chandler, AZ) as the material and an additive manufacturing printer from Fortify Inc. (Boston, MA) (e.g., the FLUX ONE), an example of one such printer which is described below with respect to FIGS. 18A and 18B. However, a person skilled in the art, in view of the present disclosures, can use AMDFs in lieu of superstrates, accounting for differences known to those skilled in the art. Moreover, a person skilled in the art will appreciate the functions, operations, configurations, and details, e.g., shapes and/or construction, of the lenses discussed herein, and thus a detailed discussion of the same is omitted herein for the sake of brevity.

Lenses of the present embodiments can be additively manufactured by controlling or tuning a dielectric constant thereof. In some embodiments, the effective Dk can be controlled by tuning or varying the volume fraction of solid-to-air constantly across the volume of the lens envelope. Varying the volume fraction can result in formation of AMDFs having non-uniform dielectric constants across a body thereof, e.g., formation of an anisotropic material in a given direction, such as the z-direction. Alternatively, in some embodiments, the dielectric constant can be tuned to a uniform value across the AMDF. For example, lenses in which the dielectric constant does not vary across a body thereof, e.g., constant-K lenses 1700, as shown in FIG. 16, can include a lens in which the Dk is uniform across the lens 1700. As shown, the constant-K lens 1700, which is pictured paired with a balanced antipodal Vivaldi antenna 1710, can use a single material, e.g., a photopolymer resin with a dielectric constant of about 2.8 Dk, in conjunction with the gyroid latticing approach to enable any number of constant-k dielectric lenses by changing the volume fraction of solid-to-air constantly across the volume of the lens envelope.

The ability to control the dielectric constant can allow the lenses of the present embodiments to mimic properties of another material, as discussed above. For example, in the constant-K lens of FIG. 16, the lens can be manufactured to behave similarly to Teflon, which has a Dk value of 3.2, despite using a photopolymer resin with a dielectric constant of about 2.8 Dk, by varying the volume fraction of the entire device to match the dielectric of Teflon for a particular frequency of interest.

In some embodiments, thin, solid dielectric skins can be created on the surfaces of the lenses of the present embodiments. These skins can protect the lattice structures of the AMDFs, while becoming a landing area for metallization on one or both of the skins.

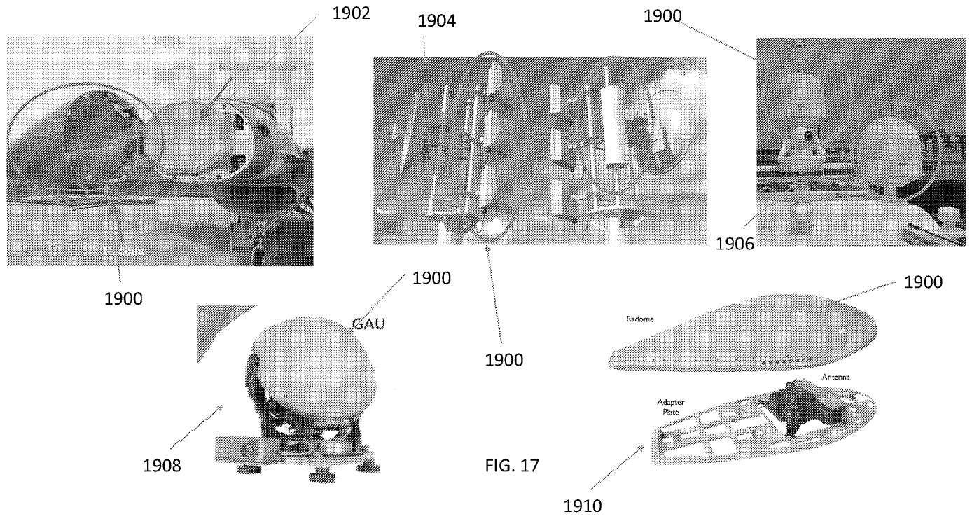

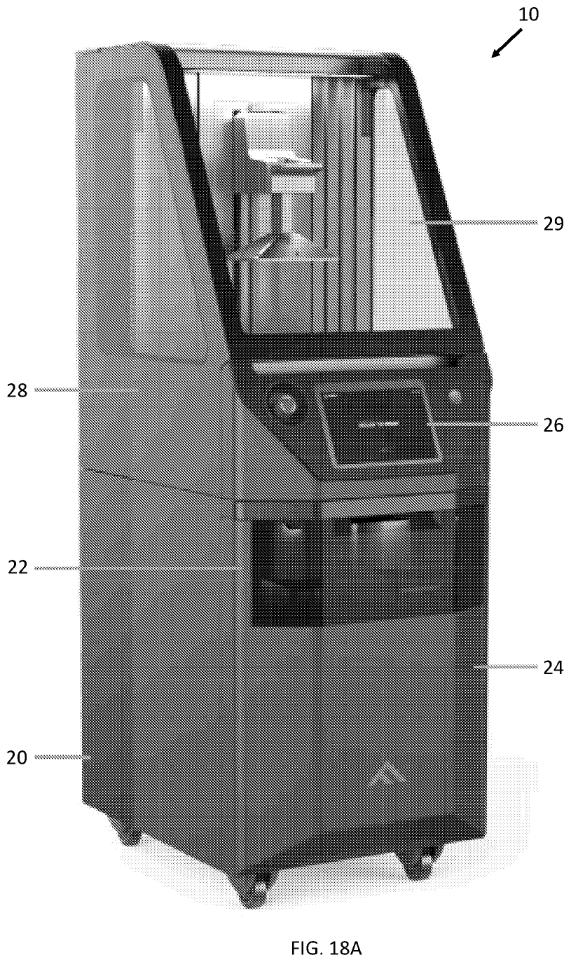

Another example of the more complex shapes of the AMDFs of the present embodiments having a curved shape can occur with respect to the manufacture of radomes. A person skilled in the art will recognize that radomes, and nosecones, which are a type of radome, can be used to protect an antenna and are typically made from transparent and/or transparent RF materials, which can function as housings that affect the behavior of electromagnetic (EM) signals, or EM waves, that pass through them in a designated manner. Some non-limiting examples of structures that can include radomes 1900 can be: a nosecone on an commercial aircraft radar antennae 1902; telecommunication towers 1904; maritime radar 1906; commercial satellite communication (SATCOM) antennae 1908; unmanned aerial vehicle (UAV) 1910; and the like, which are shown by way of non-limiting examples of the same in FIG. 17. In conventional embodiments, though RF engineers typically consider the impact of the radome on the EM signal, and account for it in design, the radome plays no active role in the function of the electromagnetics of the antenna. Using the techniques of the present embodiments, different structures can be integrated into the body of the radome to intentionally add function thereto. For example, in some embodiments, the radome can be modified to better match to air, e.g., free space, and/or have lensing capabilities integrated into the radome. The AMDFs of the present embodiments can be applied to any of these types of radomes by a person skilled in the art in view of the present disclosures. Moreover, a person skilled in the art will appreciate the functions, operations, configurations, and details, e.g., shapes and/or construction, of the radomes discussed herein, and thus a detailed discussion of the same is omitted herein for the sake of brevity.

The gyroid structures 110, 210, 310, 410 and AMDFs 510, 600, 700, 1300, 1400, 1500 provided for herein can be produced by some additive manufacturing printers, such as a vat polymerization-based printer. The printers should generally have the ability to print a low-loss RF material in specialized shapes, like the gyroid shape, the planar and conformal anisotropic foam structures, and so forth. For example, FIGS. 18A and 18B illustrate one exemplary embodiment of a FLUX CORE 3D printer 10 that can be used to form the gyroid structures and AMDFs disclosed herein or otherwise derivable from the present disclosures. A printer like the FLUX CORE 3D printer 10 provides useful abilities for these purposes because the printer is able to compress layers of highly viscous materials, and it is also able to continuously mix the material, keeping it homogeneous. Materials that can be used to form the gyroid structures, and thus the AMDF, can include a photocurable polymer that meets the specifications of the printer with which the material is being used and is generally considered to be a low-loss material. One non-limiting example of such material includes Radix™M printable dielectric material (e.g., 2.8 Dk), provided by Rogers Corporation (Chandler, AZ).

The resulting AMDFs of the present disclosure, e.g., AMDFs 510, 600, 700, 1300, 1400, 1500, can have superior mechanical strength as compared to traditional foams. This superior mechanical strength as compared to traditional foams can occur at, or at about, room temperature. For example, in some embodiments of a AMDF, the foam may not break until a pressure of at least 200 psi is applied to the AMDF, or a pressure of at least 300 psi is applied to the AMDF, or a pressure of at least 400 psi is applied to the AMDF, or a pressure of at least 430 psi is applied to the AMDF (e.g., a 1.3 Dk foam). Lower Dk foams typically result in a lower ability to handle stress, but still far superior to traditional foams. The resulting AMDFs can be able to withstand temperatures of about 180 °C or greater.

The printer 10 includes an outer casing or housing 20 in which various components of the printer 10 are disposed. The FLUX CORE 3D printer is designed to use a bottom-up printing technique, and thus includes a build plate 30 that can be advanced vertically, substantially parallel to a longitudinal axis L of the printer 10 such that the build plate 30 can be moved vertically away from a print reservoir 50 in which resin to be cured to form a desired part, such as resins as provided for above, is disposed. Generally, the build plate 30 can be advanced up and down with respect to a linear rail 32 as desired, the linear rail 32 being substantially colinear with the longitudinal axis L. As a result, the rail 32 can be considered a vertical rail. The build plate 30 can be associated with the linear rail 32 by way or one or more coupling components, such as arm or armatures 34, guides 36, 38, and/or other structures known to those skilled in the art for creating mechanical links that allow one component to move with respect to another.

As described herein, as the build plate 30 moves away from the print reservoir 50, the resin is cured to the build plate 30 and/or to already cured resin to form the printed part in a layer-by-layer manner as the build plate 30 advances away from the reservoir 50. The resin is cured, for example, by a light source and/or a radiation source, as shown a digital light projector 60. The reservoir 50 can include a glass base 52 to allow the digital light projector 60 to pass light into the reservoir 50 to cure the resin. The glass base 52 can more generally be a transparent platform through which light and/or radiation can pass to selective cure the resin. Resin can be introduced to the printer 10 by way of a materials dock 54 that can be accessible, for example via a drawer 22, formed as part of the housing 20.

One or more mixers can be included to help keep the resin viscous and homogeneous. More particularly, at least one mixer, as shown an external mixer 80, can be in fluid communication with the print reservoir 50 to allow resin to flow out of the reservoir 50, into the mixer 80 to be mixed, and then flow back into the reservoir 50 after it has been mixed by the mixer 80. The mixer 80 can be accessible, for example, via a front panel door 24 provided as part of the housing 20. At least one heating element 82 can be included for use in conjunction with the mixer 80 such that the treated (i.e., mixed) resin is also heated. In the illustrated embodiment the heating element 82 is disposed proximate to the print reservoir 50, heating the resin after it has been mixed by the mixer 80, although other location are possible, including but not limited to being incorporated with the mixer 80 to heat and mix simultaneously and/or consecutively. The resin can be heated more than once by additional heating elements as well. Resin that travels from the reservoir 50, to the mixer 80, and back to the reservoir 50 can flow through any number of conduits or tubes configured to allow resin to travel therethrough, such as the conduits 84 illustrated in FIG. 18B.

The resin can also flow through a reservoir manifold 56, which can be disposed above the print reservoir 50. The manifold 56 can serve a variety of purposes, including but not limited to helping to maintain the position of the reservoir 50 during operation, and helping to facilitate mechanical, electrical, and fluid connections between the reservoir and other components of the printer 10. For example, the manifold can be designed to allow resin to be mixed and/or heated to flow out of the reservoir 50, as well as allow mixed and/or heated resin to flow into the reservoir 50 via ports formed therein. Electrical connections to help operate various features associated with the reservoir 50, such as monitoring of a level of resin and/or monitoring an orientation of one or more components disposed and/or otherwise situated with respect to the reservoir 50, can be passed through the manifold 56. The electrical connections may be associated with various electronics and the like housed within the printer 10, for example in an electronics panel 90. Additional details about a reservoir manifold are provided for in International Patent Application No. WO 2021/217102, entitled “Manifold and Related Methods for Use with a Reservoir for Additive Manufacturing,” the contents of which is incorporated by reference herein in its entirety.

A touch screen 26 or other user interface can be included as part of the housing 20 to allow a user to input various parameters for a print job and/or for instructions, signals, warnings, or other information to be passed along by any systems of the printer 10 to a user. Still further, the housing 20 can include an openable and/or removable hood 28 that enables a printed part, as well as components of the printer 10, to be accessed. The hood 28 can also include a viewing portion, such as a window 29, that allows a user to view a print job being performed. As shown, the build plate 30, and thus a part being printed that will be attached to the build plate 30, can be seen through the window 29. Further, the reservoir 50, manifold 56, and other components of the printer 10 can also be visible through the window 29.

In use, the gyroid structures and/or AMDF 510, 600, 700, 1300, 1400, 1500 can be produced using printers like the printer 10 by first creating a design for the gyroid structure and/or the AMDF 510, 600, 700, 1300, 1400, 1500. In an instance in which the AMDF is going to be used in conjunction with an RF device, such as an antenna, an RF design engineer can design an antenna structure that needs a portion of the volume of the structure to have a low effective dielectric constant and that is able to be made of a low-loss material. The resulting design can be converted to a lattice structure, which in turn can be printed by the printer. Additive manufacturing processes can be carried out, including the layer-by-layer production of the antenna, complete with processing, cleaning, and UV curing actions. In instances in which a copper plating or other suitable metal is desired to be included as part of the structure and/or AMDF 510, 600, 700, 1300, 1400, 1500, such plating can be added to the printed portion through select metallization processes. The plating can be placed on a top layer, a bottom layer, and/or in conical-plated through holes with thin, solid walls within the structure and/or AMDF 510, 600, 700, 1300, 1400, 1500. Subsequently, the structures and/or AMDF 510, 600, 700, 1300, 1400, 1500 can be laminated to a PCB stack-up. An example of such a stack-up can be a beam-forming network with feed network on a PCB laminated to the AMDF 510, 600, 700, 1300, 1400, 1500 with a metallized lower patch antenna on a bottom of the foam, a plated through hole to the top layer, and a copper patch antenna on the upper layer. There can be a concurrent lamination to a Radome structure covering the upper patches. The resulting device can be placed at the front end of a radar or communications system as a patch-based phased array antenna.

Examples of the above-described embodiments can include the following:

1. A lattice-based structure, comprising:
a body that comprises a mix of low-loss dielectric material and air, the body including:
   a first skin surface disposed at a first end of the body;
   a second skin surface disposed at a second end of the body; and
   a plurality of columns disposed between the first skin surface and the second skin surface,
wherein the body is anisotropic in a single direction.

2. The structure of claim 1, wherein an effective Dk of the body in the single direction is smaller than an effective Dk of the body in any other direction.

3. The structure of claim 1 or claim 2, wherein the effective Dk is non-uniform in the single direction.

4. The structure of any of claims 2 to 4, wherein the single direction is a direction that travels through a short axis of the body.

5. The structure of any of claims 2 to 5, wherein the effective Dk of the body is approximately in a range of about 1.01 to about 1.08.

6. The structure of any of claims 1 to 6, wherein the first skin surface and the second skin surface are planar such that the first skin surface and the second skin surface lie substantially parallel to one another. po 7. The structure of any of claims 1 to 7, wherein the body is configured to directly interface with one or more components of a radio frequency device to maintain conformance therewith.

8. The structure of claim 7, wherein the body is one or more of: (i) in contact but not affixed to the one or more components; (ii) affixed to the one or more components; or (iii) directly deposited onto the one or more components.

9. The structure of claim 8, wherein the body is one or more of: (i) in contact but not affixed to the one or more components; or (ii) affixed to the one or more components.

10. The structure of claim 8 or claim 9, wherein the body is configured to maintain an effective Dk normal to a surface of one or more of the first skin or the second skin.

11. The structure of any of claims 1 to 10, wherein the plurality of columns are arranged in a honeycomb pattern having a plurality of cells disposed adjacent to one another.

12. The structure of any of claims 1 to 11, wherein the body has a compressive strength approximately in a range of about 6 MPa to about 30 MPa.

13. The structure of any of claims 1 to 12, wherein the body is configured to release the air therefrom upon lamination such that no more than about 10% of air gaps that existed prior to lamination continue to exist after lamination of the body.

14. The structure of any of claims 1 to 13, wherein the body is configured to withstand at least approximately 400 psi of pressure before breaking.

15. The structure of any of claims 1 to 14, wherein the structure is configured to withstand a temperature of at least about 180 °C.

16. The structure of any of claims 1 to 15, wherein the plurality of columns further comprises a plurality of gyroid structures.

17. The structure of claim 16, wherein one or more of the first skin surface or the second skin surface comprises a metallic plated structure.

18. A method for manufacturing a radio frequency device, comprising:
additively manufacturing a foam for use with an antenna structure, the foam having a plurality of columns made up of mix of low-loss dielectric material and air, and a porous body that is anisotropic in a single direction; and
directly interfacing the foam with one or more components of the antenna structure to maintain conformance therewith.

19. The method of claim 18, wherein directly interfacing further comprises one or more of: (i) maintaining in contact, but not affixing the foam to the one or more components; (ii) affixing the foam to the one or more components; or (iii) directly depositing the foam onto the one or more components.

20. The method of claim 18 or claim 19, wherein directly interfacing comprises laminating the foam to the one or more components.

21. The method of claim 20, wherein laminating the foam eliminates air gaps within the foam.

22. The method of claim 21, wherein laminating the foam to the one or more components further comprises releasing air from the foam such that no more than about 10% of air gaps that existed prior to lamination continue to exist after lamination.

23. The method of any of claims 20 to 22, wherein a compressive strength of the laminated foam is at least an order of magnitude higher than a compressive strength of the foam prior to lamination.

24. The method of any of claims 18 to 23, wherein the one or more components further comprise one or more of a ground plane, a microstrip line, or a patch to form a conformal microstrip fed patch antenna or a coplanar waveguide fed patch antenna.

25. The method of any of claims 18 to 24, further comprising tuning one or more parameters of the foam to modulate an effective Dk of the foam.

26. The method of claim 25, wherein the one or more parameters comprise at least one of a thickness, a density, or a height of the plurality of columns.

27. The method of any of claims 18 to 26, further comprising conforming the foam to the antenna structure to match a profile of the foam.

28. The method of any of claims 18 to 27, further comprising attaching one or more skin layers to the foam.

29. The method of any of claims 18 to 28, further comprising designing the antenna structure with a portion of the volume of the antenna structure having a low effective dielectric constant and being made of a low-loss material.

30. A lattice-based structure, comprising:
a foam spacer having an open-celled body that comprises a mix of low-loss dielectric material and air,
wherein the body is anisotropic in a single direction.

31. The structure of claim 30, wherein the foam spacer is capable of being disposed within a cavity of an antenna without being associated with a skin layer.

32. The structure of claim 30 or claim 31, wherein the body includes a low effective Dk in the single direction normal to a curve of the profile of the body.

One skilled in the art will appreciate further features and advantages of the present disclosure based on the above-described embodiments. Accordingly, the disclosure is not to be limited by what has been particularly shown and described. Further, a person skilled in the art, in view of the present disclosures, will understand how to implement the disclosed systems and methods provided for herein in conjunction with at least vat polymerization printers, including SLA-style and DLP-style additive manufacturing printers. All publications and references cited herein are expressly incorporated herein by reference in their entireties.

Some non-limiting claims are provided below.

What is claimed is:

1. A lattice-based structure, comprising:
a body that comprises a mix of low-loss dielectric material and air, the body including:
a first skin surface disposed at a first end of the body;
a second skin surface disposed at a second end of the body; and
a plurality of columns disposed between the first skin surface and the second skin surface,
wherein the body is anisotropic in a single direction.

2. The structure of claim 1, wherein an effective Dk of the body in the single direction is smaller than an effective Dk of the body in any other direction.

3. The structure of claim 2, wherein the effective Dk is non-uniform in the single direction.

4. The structure of claim 2, wherein the single direction is a direction that travels through a short axis of the body.

5. The structure of claim 2, wherein the effective Dk of the body is approximately in a range of about 1.01 to about 1.08.

6. The structure of claim 1, wherein the first skin surface and the second skin surface are planar such that the first skin surface and the second skin surface lie substantially parallel to one another.

7. The structure of claim 1, wherein the body is configured to directly interface with one or more components of a radio frequency device to maintain conformance therewith.

8. The structure of claim 7, wherein the body is one or more of: (i) in contact but not affixed to the one or more components; (ii) affixed to the one or more components; or (iii) directly deposited onto the one or more components.

9. The structure of claim 8, wherein the body is one or more of: (i) in contact but not affixed to the one or more components; or (ii) affixed to the one or more components.

10. The structure of claim 8, wherein the body is configured to maintain an effective Dk normal to a surface of one or more of the first skin or the second skin.

11. The structure of claim 1, wherein the plurality of columns are arranged in a honey comb pattern having a plurality of cells disposed adjacent to one another.

12. The structure of claim 1, wherein the body has a compressive strength approximately in a range of about 6 MPa to about 30 MPa.

13. The structure of claim 1, wherein the body is configured to release the air therefrom upon lamination such that no more than about 10% of air gaps that existed prior to lamination continue to exist after lamination of the body.

14. The structure of claim 1, wherein the body is configured to withstand at least approximately 400 psi of pressure before breaking.

15. The structure of claim 1, wherein the structure is configured to withstand a temperature of at least about 180 °C.

16. The structure of claim 1, wherein the plurality of columns further comprises a plurality of gyroid structures.

17. The structure of claim 16, wherein one or more of the first skin surface or the second skin surface comprises a metallic plated structure.

18. A method for manufacturing a radio frequency device, comprising:
additively manufacturing a foam for use with an antenna structure, the foam having a plurality of columns made up of mix of low-loss dielectric material and air, and a porous body that is anisotropic in a single direction; and
directly interfacing the foam with one or more components of the antenna structure to maintain conformance therewith.

19. The method of claim 18, wherein directly interfacing further comprises one or more of: (i) maintaining in contact, but not affixing the foam to the one or more components; (ii) affixing the foam to the one or more components; or (iii) directly depositing the foam onto the one or more components.

20. The method of claim 18, wherein directly interfacing comprises laminating the foam to the one or more components.

21. The method of claim 20, wherein laminating the foam eliminates air gaps within the foam.

22. The method of claim 21, wherein laminating the foam to the one or more components further comprises releasing air from the foam such that no more than about 10% of air gaps that existed prior to lamination continue to exist after lamination.

23. The method of claim 20, wherein a compressive strength of the laminated foam is at least an order of magnitude higher than a compressive strength of the foam prior to lamination.

24. The method of claim 18, wherein the one or more components further comprise one or more of a ground plane, a microstrip line, or a patch to form a conformal microstrip fed patch antenna or a coplanar waveguide fed patch antenna.

25. The method of claim 18, further comprising tuning one or more parameters of the foam to modulate an effective Dk of the foam.

26. The method of claim 25, wherein the one or more parameters comprise at least one of a thickness, a density, or a height of the plurality of columns.

27. The method of claim 18, further comprising conforming the foam to the antenna structure to match a profile of the foam.

28. The method of claim 18, further comprising attaching one or more skin layers to the foam.

29. The method of claim 18, further comprising designing the antenna structure with a portion of the volume of the antenna structure having a low effective dielectric constant and being made of a low-loss material.

30. A lattice-based structure, comprising:
a foam spacer having an open-celled body that comprises a mix of low-loss dielectric material and air,
wherein the body is anisotropic in a single direction.

31. The structure of claim 30, wherein the foam spacer is capable of being disposed within a cavity of an antenna without being associated with a skin layer.

32. The structure of claim 30, wherein the body includes a low effective Dk in the single direction normal to a curve of the profile of the body.
